(19) United States
(12) Patent Application Publication
(10) Pub. No.: US 2015/0249736 A1
(43) Pub. Date: Sep. 3, 2015

(54) Notification of Muting During Voice Activity for Multiple Muters

(71) Applicant: Plantronics, Inc., Santa Cruz, CA (US)

(72) Inventors: Timothy P. Johnston, Los Gatos, CA (US); Richard A. Dunning, JR., Los Gatos, CA (US)

(73) Assignee: Plantronics, Inc., Santa Cruz, CA (US)

(21) Appl. No.: 14/194,460

(22) Filed: Feb. 28, 2014

(51) Int. Cl. H04M 1/725

(52) U.S. Cl. CPC H04M 1/72597

(57) ABSTRACT

A communication device having corresponding computer-readable media comprises: a receiver configured to receive, into the communication device, i) audio transmitted by a headset, ii) a voice activity notification, where the voice activity notification indicates the headset is detecting voice activity in the audio, iii) a mute status notification, where the mute status notification indicates whether a first muter in the headset is configured to block or pass the audio; a second muter configured to pass or block the audio; and a notifier configured to provide a user-perceivable notification responsive to contemporaneous occurrence of i) the headset detecting the voice activity, and ii) one or both of the first and second muters being configured to block the audio; where the user-perceivable notification indicates which of the first and second muters are configured to block the audio.

### FIELD

The present disclosure relates generally to telecommunications. More particularly, the present disclosure relates to muting of audio during voice activity.

### BACKGROUND

Communication devices such as telephones and the like typically provide a muter that allows a user to prevent transmission of audio from the communication device. For example, a call participant may activate the muter during a telephone call to conduct a private conversation. The call participant may then deactivate the muter to continue the telephone call.

Users often forget the status of their muters. For example, when a call participant wrongly believes his muter is active, he may accidentally convey private comments to the other call participants. Alternatively, when a first call participant wrongly believes his muter is inactive, the other call participants may not hear what the first call participant says, which may require the first call participant to repeat his comments, possibly causing delay and confusion on the call.

Further complications arise when multiple muters are employed. For example, a user may employ a headset connected to a telephone, where both the headset and the telephone include muters. In such a case, the user must keep track of the status of both muters. In another case, a user may employ a headset connected to a computer that is connected to a conference bridge where all three devices have muters. In such a case, the user must keep track of the status of three muters.

### SUMMARY

In general, in one aspect, an embodiment features a communication device comprising: a receiver configured to receive, into the communication device, i) audio transmitted by a headset, ii) a voice activity notification, wherein the voice activity notification indicates the headset is detecting voice activity in the audio, iii) a mute status notification, wherein the mute status notification indicates whether a first muter in the headset is configured to block or pass the audio; a second muter configured to pass or block the audio; and a notifier configured to provide a user-perceivable notification responsive to contemporaneous occurrence of i) the headset detecting the voice activity, and ii) one or both of the first and second muters being configured to block the audio; wherein the user-perceivable notification indicates which of the first and second muters are configured to block the audio.

Embodiments of the communication device can include one or more of the following features. Some embodiments comprise a user-operable control; and a muter controller configured to configure the first and second muters to both pass or both block the audio responsive to operation of the user-operable control. Some embodiments comprise a user-operable control configured to select one of the first and second muters; and a muter controller configured to configure the one of the first and second muters to pass or block the audio responsive to operation of the user-operable control. Some embodiments comprise a transmitter configured to transmit a message from the communication device, wherein the message indicates which of the first and second muters are configured to block the audio. In some embodiments, the receiver is a first receiver, the mute status notification is a first mute status notification, and the communication device further comprises: a transmitter configured to transmit the audio; and a second receiver configured to receive a second mute status notification from a conference bridge receiving the audio, wherein the second mute status notification indicates whether a third muter in the conference bridge is configured to block the audio; wherein the notifier is further configured to provide the user-perceivable notification responsive to contemporaneous occurrence of i) the headset detecting the voice activity, and ii) one or more of the first, second and third muters being configured to block the audio; wherein the user-perceivable notification indicates which of the first, second and third muters are configured to block the audio. In some embodiments, the transmitter is further configured to transmit a message from the communication device, wherein the message indicates which of the first, second and third muters are configured to block the audio. Some embodiments comprise a user-operable control; and a muter controller configured to configure the first, second and third muters to all pass or all block the audio responsive to operation of the user-operable control.

In general, in one aspect, an embodiment features a headset comprising: a microphone; a transmitter configured to transmit, from the headset, audio produced by the microphone; a voice activity detector configured to detect voice activity in the audio; a first muter configured to i) pass the audio to the transmitter, or ii) block the audio from reaching the transmitter; a receiver configured to receive a mute status notification into the headset, wherein the mute status notification indicates whether a second muter, disposed in a communication device receiving the audio from the headset, is configured to block the audio; and a notifier configured to provide a user-perceivable notification responsive to contemporaneous occurrence of i) the voice activity detector detecting the voice activity in the audio, and ii) one or both of the first and second muters being configured to block the audio; wherein the user-perceivable notification identifies which of the first and second muters is configured to block the audio.

Embodiments of the headset can include one or more of the following features. Some embodiments comprise a user-operable control; and a muter controller configured to configure the first and second muters to both pass or both block the audio responsive to operation of the user-operable control. Some embodiments comprise a user-operable control configured to select one of the first and second muters; and a muter controller configured to configure the one of the first and second muters to pass or block the audio responsive to operation of the respective user-operable control. In some embodiments, the transmitter is further configured to transmit a message from the headset, wherein the message indicates which of the first and second muters are configured to block the audio. In some embodiments, the mute status notification is a first mute status notification; the receiver is further configured to receive a second mute status notification, wherein the second mute status notification indicates whether a third muter, disposed in a conference bridge receiving the audio, is configured to block the audio; the notifier is further configured to provide the user-perceivable notification responsive to contemporaneous occurrence of i) the voice activity detector detecting the voice activity in the audio, and ii) one or more of the first, second and third muters being configured to block the audio; and the user-perceivable notification indicates which of the first, second and third muters are configured to block the audio. In some embodiments, the transmitter is further configured to transmit a message from the headset, wherein the message indicates which of the first, second and third muters are configured to block the audio. Some embodiments comprise a user-operable control; and a muter controller configured to configure the first, second and third muters to all pass or all block the audio responsive to operation of the user-operable control.

In general, in one aspect, an embodiment features computer-readable media embodying instructions executable by a computer disposed in a communication device to perform functions comprising: receiving audio from a headset; receiving a voice activity notification, wherein the voice activity notification indicates voice activity being detected in the audio; receiving a mute status notification, wherein the mute status notification indicates whether a first muter in the headset is configured to block or pass the audio; determining whether a second muter disposed in the communication device is configured to pass or block the audio; and causing a notifier to provide a user-perceivable notification responsive to contemporaneous occurrence of i) the voice activity being detected in the audio, and ii) one or both of the first and second muters being configured to block the audio; wherein the user-perceivable notification indicates which of the first and second muters are configured to block the audio.

Embodiments of the computer-readable media can include one or more of the following features. Some embodiments comprise causing a muter controller disposed in the communication device to configure the first and second muters to both pass or both block the audio responsive to operation of a user-operable control disposed in the communication device. In some embodiments, the functions further comprise: causing a muter controller disposed in the communication device to configure one of the first and second muters to pass or block the audio responsive to operation of a user-operable control disposed in the communication device. In some embodiments, the functions further comprise: causing a transmitter disposed in the communication device to transmit a message from the communication device, wherein the message indicates which of the first and second muters are configured to block the audio. In some embodiments, the receiver is a first receiver, wherein the mute status notification is a first mute status notification, and wherein the functions further comprise: causing a transmitter disposed in the communication device to transmit the audio; receiving a second mute status notification from a conference bridge receiving the audio, wherein the second mute status notification indicates whether a third muter in the conference bridge is configured to block the audio; and causing the notifier to provide the user-perceivable notification responsive to contemporaneous occurrence of i) the voice activity being detected in the audio, and ii) one or more of the first, second and third muters being configured to block the audio; wherein the user-perceivable notification indicates which of the first, second and third muters are configured to block the audio. In some embodiments, the functions further comprise: causing a muter controller disposed in the communication device to configure the first, second and third muters to all pass or all block the audio responsive to operation of a user-operable control disposed in the communication device.

The details of one or more implementations are set forth in the accompanying drawings and the description below. Other features will be apparent from the description and drawings, and from the claims.

### DESCRIPTION OF DRAWINGS

FIG. 1 shows elements of a communication system that includes a headset and a smartphone according to some embodiments of the present disclosure.

FIG. 2 shows elements of a communication system that includes a headset, a smartphone, and a conference bridge according to some embodiments of the present disclosure.

FIG. 3 shows elements of the headset of FIGS. 1 and 2 according to some embodiments of the present disclosure.

FIG. 4 shows elements of the smartphone of FIGS. 1 and 2 according to some embodiments of the present disclosure.

FIG. 5 shows elements of the conference bridge of FIG. 2 according to some embodiments of the present disclosure.

FIG. 6 shows a process for the communication system of FIG. 1 according to some embodiments of the present disclosure.

FIGS. 7A and 7B show a process for the communication system of FIG. 2 according to some embodiments of the present disclosure.

FIG. 8 shows a headset-controlled muting process for the communication system of FIG. 2 according to some embodiments of the present disclosure.

FIG. 9 shows a smartphone-controlled muting process for the communication system of FIG. 2 according to some embodiments of the present disclosure.

FIG. 10 shows an example display for a conferencing app according to some embodiments of the present disclosure.

The leading digit(s) of each reference numeral used in this specification indicates the number of the drawing in which the reference numeral first appears.

### DETAILED DESCRIPTION

Embodiments of the present disclosure provide notification of muting during voice activity for multiple muters. For example, when a call participant using a headset connected to a smartphone speaks while either or both of the devices are muted, a notification is provided to the call participant that identifies the muted devices. Now several embodiments are described. It will be appreciated that other embodiments can be implemented by combining the features of the described embodiments. Other features are contemplated as well.

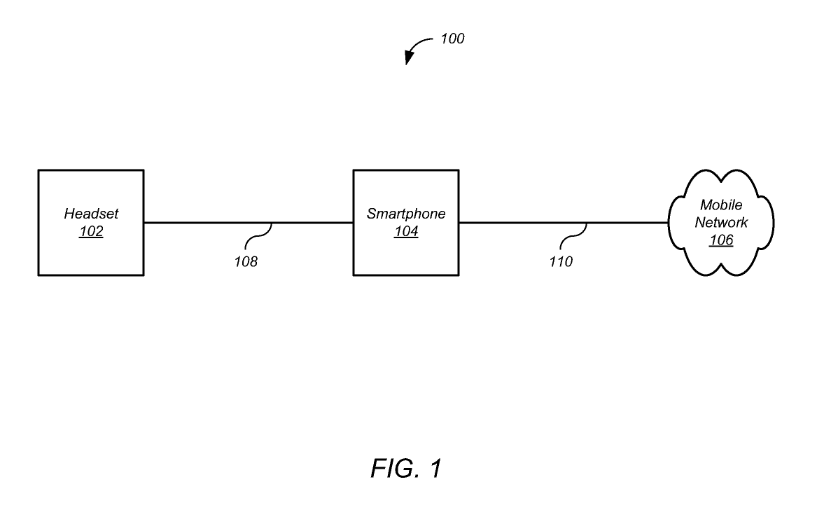

FIG. 1 shows elements of a communication system 100 that includes a headset and a smartphone according to some embodiments of the present disclosure. Although in the described embodiments, the elements of the communication system 100 are presented in one arrangement, other embodiments may feature other arrangements, as will be apparent to one skilled in the relevant arts based on the disclosure and teachings provided herein. For example, the elements of the communication system 100 may be implemented in hardware, software, or combinations thereof.

Referring now to FIG. 1, the communication system 100 includes a headset 102, a smartphone 104, and a mobile network 106. In other embodiments, the smartphone 104 may be replaced by a feature phone, a desk phone, a softphone, and the like. The softphone can be implemented as a computer executing a softphone application, a browser-based softphone, other communication mechanisms such as Web Real-Time Communication (webRTC), and the like. In other embodiments, the mobile network 106 may be replaced by a computer network or the like. The headset 102 and the smartphone 104 may communicate over the channel 108 such as a wireless link, a wired link, or the like. The wireless link may be a Bluetooth link, a Digital Enhanced Cordless Telecommunications (DECT) link, a WiFi link, or the like. The smartphone 104 and the mobile network 106 may communicate over a channel 110 such as a mobile phone channel or the like. The headset 102 may exchange audio, status messages, command messages, and the like with the smartphone 104 over the channel 108. The smartphone 104 may exchange audio, status messages, and command messages with the mobile network 106 over the mobile phone channel 110.

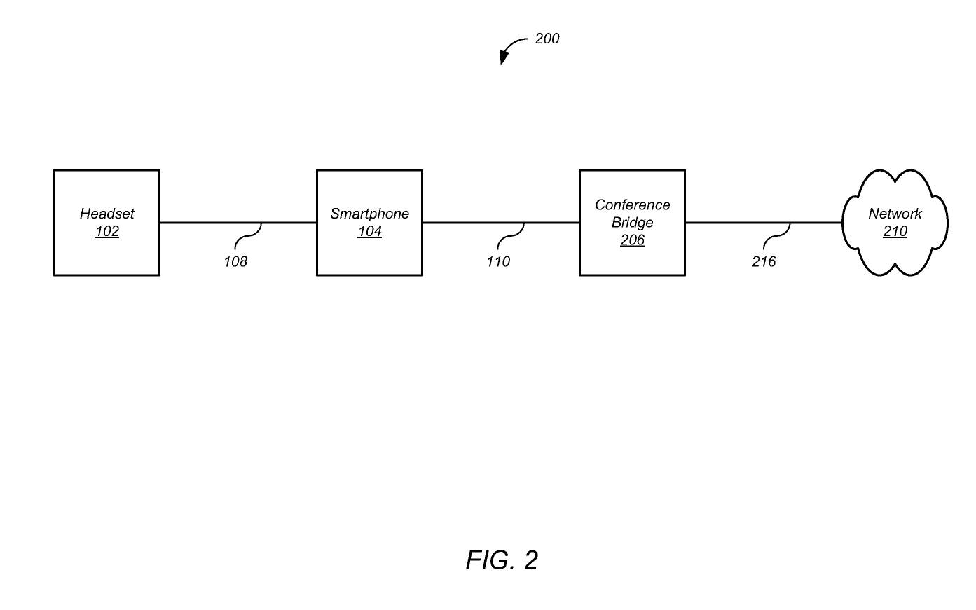

FIG. 2 shows elements of a communication system 200 that includes a headset, a smartphone, and a conference bridge according to some embodiments of the present disclosure. Although in the described embodiments, the elements of the communication system 200 are presented in one arrangement, other embodiments may feature other arrangements, as will be apparent to one skilled in the relevant arts based on the disclosure and teachings provided herein. For example, the elements of the communication system 200 may be implemented in hardware, software, or combinations thereof.

Referring now to FIG. 2, the communication system 200 includes the headset 102, the smartphone 104, a conference bridge 206, and a network 210. In other embodiments, the smartphone 104 may be replaced by a feature phone, a desk phone, a softphone, and the like. The softphone can be implemented as a computer executing a softphone application, a browser-based softphone, other communication mechanisms such as webRTC, and the like. The headset 102 and the smartphone 104 may communicate over the channel 108. The smartphone 104 and the conference bridge 206 may communicate over the channel 110. The conference bridge 206 may communicate with the network 210 over a channel 216 such as a voice over Internet protocol (VOIP) channel or the like.

The headset 102 may exchange audio, status messages, command messages, and the like with the smartphone 104 over the channel 108. The smartphone 104 may exchange audio, status messages, and command messages with the conference bridge 206 over the channel 110. The conference bridge 206 may exchange audio, status messages, and command messages with the network 210 over the channel 216.

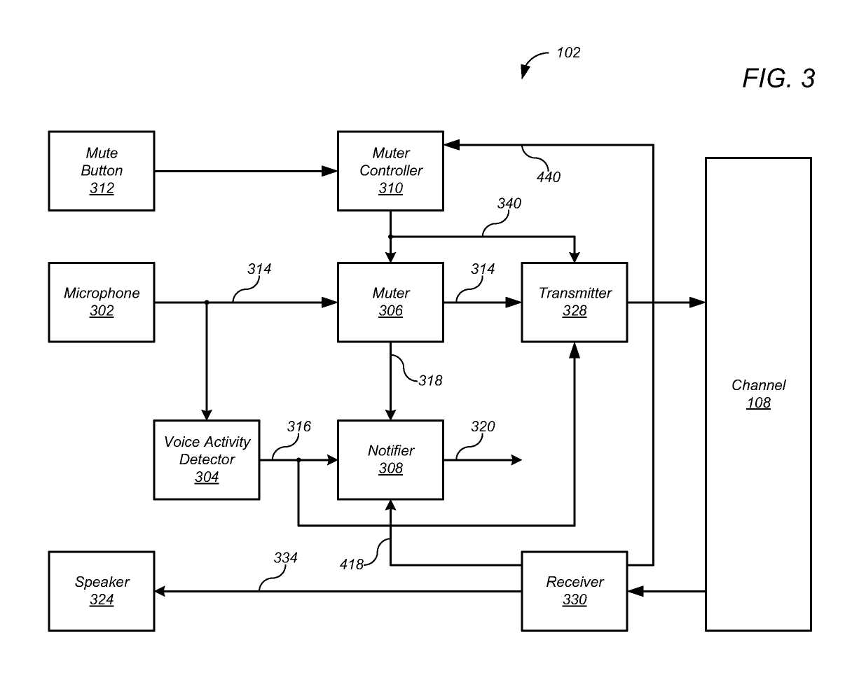

FIG. 3 shows elements of the headset 102 of FIGS. 1 and 2 according to some embodiments of the present disclosure. Although in the described embodiments, the elements of the headset 102 are presented in one arrangement, other embodiments may feature other arrangements, as will be apparent to one skilled in the relevant arts based on the disclosure and teachings provided herein. For example, the elements of the headset 102 may be implemented in hardware, software, or combinations thereof.

Referring now to FIG. 3, the headset 102 may include a microphone 302, a voice activity detector 304, a muter 306, a notifier 308, a mute controller 310, and a mute button 312. The headset 102 may further include a speaker 324, a transmitter 328, and a receiver 330. The voice activity detector 304, the muter 306, the notifier 308, the muter controller 310, the transmitter 328, and the receiver 330 may be implemented as one or more electronic circuits. One or more of the electronic circuits may be implemented as one or more integrated circuits, one or more processors, and the like. The notifier 308 may be implemented as an optical device, an electronic device, as an electro-mechanical device, or the like. The transmitter 328 and the receiver 330 exchange signals with one or more other devices, such as the smartphone 104, over the channel 108. The channel 108 may be implemented as a wired channel or a wireless channel. The wireless channel may be a Bluetooth link, a DECT link, a WiFi link, or the like.

In operation, the microphone 302 may produce output audio 314 in accordance with sound received by the microphone 302. When not muted, the muter 306 may pass the audio 314 to the transmitter 328. The transmitter 328 may transmit the audio 314 over the channel 108. The receiver 330 may receive signals over the channel 108 that represent input audio 334, and may provide the input audio 334 to the speaker 324. The speaker 324 may produce sound responsive to the input audio 334.

A user may control the muter 306 using the mute button 312. Responsive to operation of the mute button 312, the muter controller 310 may issue a mute control signal 340. The transmitter 328 may transmit the mute control signal 340 over the channel 108. In accordance with the mute control signal 340, the muter 306 may either pass or block the output audio 314, and may generate a mute status signal 318 that indicates whether the muter 306 is passing or blocking the output audio 314. The voice activity detector 304 may detect voice activity in the output audio 314, and may generate a voice activity signal 316 that represents the detected voice activity. For example, the voice activity signal 316 may be a bi-level signal where one level indicates a presence of voice activity, and the other level indicates an absence of voice activity. The notifier 308 may provide a user-perceivable notification 320. The user-perceivable notification 320 may include vibration, light, sound, and the like.

A user may control a muter in a remote device connected to the headset 102 over the channel 108 using the mute button 312. For example, the remote device may be a smartphone 104, softphone, computer, conference bridge 206, or the like. To control the remote muter, the mute button 312 may cause the muter controller 310 to provide the mute control signal 340, which may be transmitted over the channel 342 by the transmitter 328.

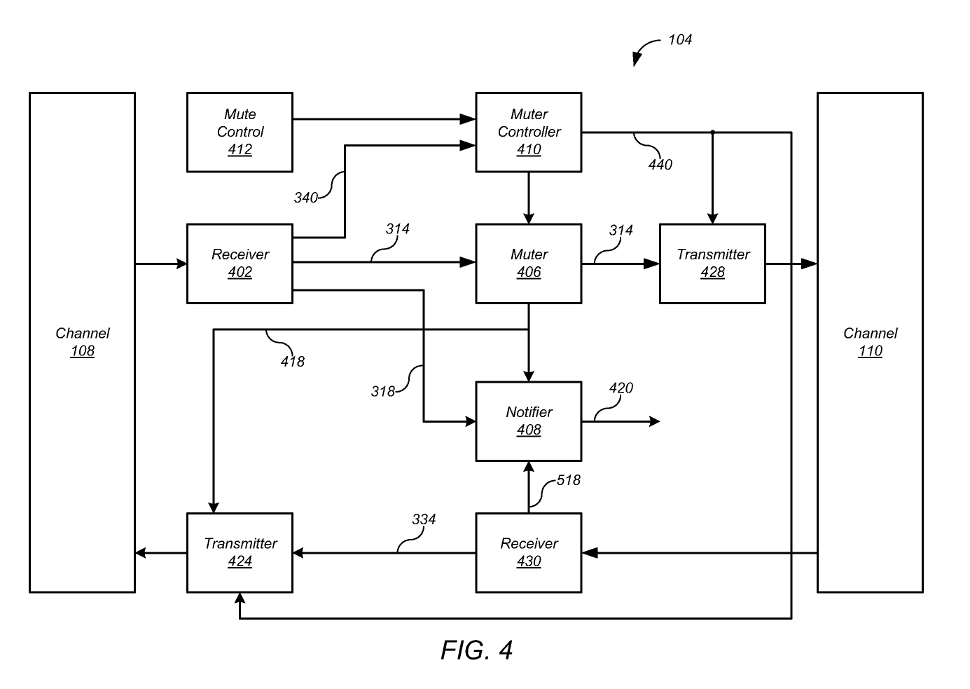

FIG. 4 shows elements of the smartphone 104 of FIGS. 1 and 2 according to some embodiments of the present disclosure. The smartphone 104 may be used as the smartphone 104 in the communication system 100 of FIG. 1. The smartphone 104 may be used as the smartphone 104 in the communication system 200 of FIG. 2. Although in the described embodiments, the elements of the smartphone 104 are presented in one arrangement, other embodiments may feature other arrangements, as will be apparent to one skilled in the relevant arts based on the disclosure and teachings provided herein. For example, the elements of the smartphone 104 may be implemented in hardware, software, or combinations thereof.

Referring now to FIG. 4, the smartphone 104 may include receivers 402 and 430, transmitters 424 and 428, a muter 406, a notifier 408, a muter controller 410, and a mute control 412. The mute control 412 may be implemented as a mechanical button, soft button, or the like. The voice activity detector 404, the muter 406, the notifier 408, the muter controller 410, the receivers 402 and 430, and the transmitters 424 and 428 may be implemented as one or more electronic circuits. One or more of the electronic circuits may be implemented as one or more integrated circuits, one or more processors, and the like. The notifier 408 may be implemented as an optical device, an electronic device, as an electro-mechanical device, or the like. The transmitter 428 and the receiver 430 may exchange signals with one or more other devices, such as the conference bridge 206, over a channel 110. In one embodiment, the channel 110 may be implemented as a wireless mobile phone communications channel. The transmitter 424 and the receiver 402 may exchange signals with one or more other devices, such as the headset 102, over the channel 108. The channel 108 may be implemented as a wired channel or a wireless channel. The wireless channel may be a Bluetooth link, a DECT link, a WiFi link, or the like.

In operation, the receiver 402 may receive audio 314 over the channel 108. When not muted, the muter 406 may pass the audio 314 to the transmitter 428. The transmitter 428 may transmit the audio 314 over the channel 110. The receiver 430 may receive the audio 334 over the channel 108, and may provide the audio 334 to the transmitter 424. The transmitter 424 may transmit the audio 334 over the channel 108.

A user may control the muter 406 using the mute control 412. Responsive to operation of the mute control 412, the muter controller 410 may issue a mute control signal 440. The transmitter 428 may transmit the mute control signal 440 over the channel 110. The transmitter 424 may transmit the mute control signal 440 over the channel 108. In accordance with the mute control signal 440, the muter 406 may either pass or block the output audio 314, and may generate a mute status signal 418 that indicates whether the muter 406 is passing or blocking the audio 314. The notifier 408 may provide a user-perceivable notification 420. The user-perceivable notification 420 may include vibration, light, sound, and the like.

A user may control a muter in a remote device connected to the smartphone 104 over the channel 108 or the channel 110 using the mute control 412. For example, the mute control 412 may be implemented as one or more soft buttons on a display of the smartphone 104. The soft buttons may allow the user to control the smartphone muter 406, as well as one or more remote muters. For example, the remote device may be a headset, a conference bridge, or the like. To control the remote muter, the mute control 412 may cause the muter controller 410 to provide the mute control signal 440, which may be transmitted over the channel 108 or the channel 110 by the transmitter 424 or the transmitter 428. In some embodiments, a voice activity detector may be incorporated in the smartphone 104, and its output may be used to trigger a user-perceiveable notification in the smartphone 104, as well as in remote devices.

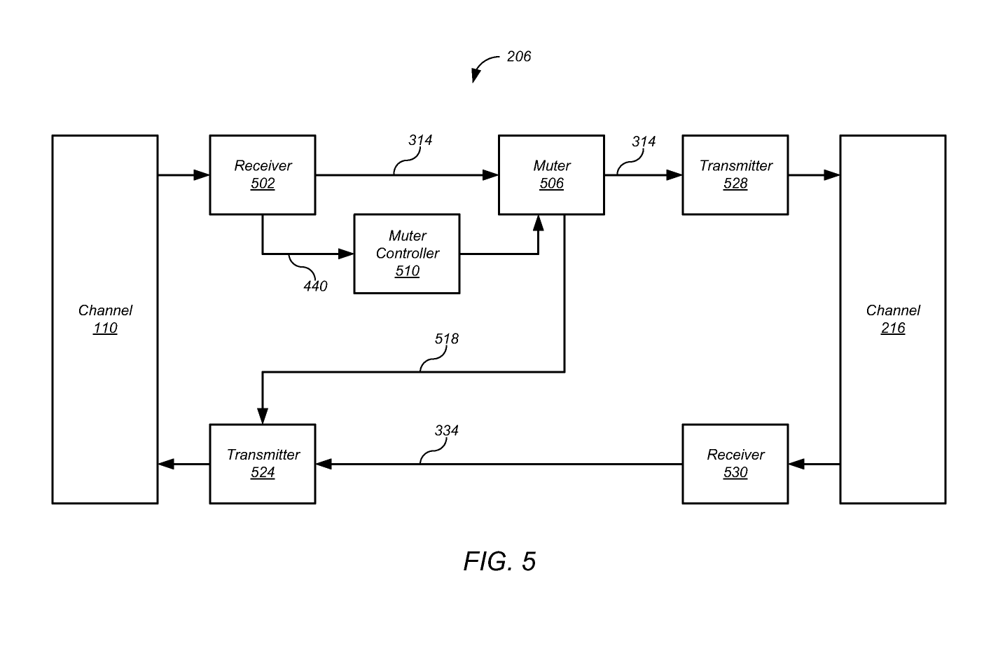

FIG. 5 shows elements of the conference bridge 206 of FIG. 2 according to some embodiments of the present disclosure. The conference bridge 206 may be used as the conference bridge 206 in the communication system 200 of FIG. 2. Although in the described embodiments, the elements of the conference bridge 206 are presented in one arrangement, other embodiments may feature other arrangements, as will be apparent to one skilled in the relevant arts based on the disclosure and teachings provided herein. For example, the elements of the conference bridge 206 may be implemented in hardware, software, or combinations thereof. The conference bridge 206 may be implemented as a teleconferencing bridge, videoconferencing bridge, and the like.

Referring now to FIG. 5, the conference bridge 206 may include receivers 502 and 530, transmitters 524 and 528, a muter 506, and a muter controller 510. The muter 506, the muter controller 510, the receivers 502 and 530, and the transmitters 524 and 528 may be implemented as one or more electronic circuits. One or more of the electronic circuits may be implemented as one or more integrated circuits, one or more processors, and the like. The transmitter 528 and the receiver 530 may exchange signals with one or more other devices over the channel 216. The transmitter 524 and the receiver 502 may exchange signals with one or more other devices, such as the smartphone 104, over the channel 110.

In operation, the receiver 502 may receive audio 314 over the channel 110. When not muted, the muter 506 may pass the audio 314 to the transmitter 528. The transmitter 528 may transmit the audio 314 over the channel 216. The receiver 530 may receive the audio 334 over the channel 216, and may provide the audio 334 to the transmitter 524. The transmitter 524 may transmit the audio 334 over the channel 110.

The receiver 502 may receive a mute control signal 440 over the channel 110. The muter controller 510 may control the muter 506 in accordance with the mute control signal 440. In accordance with the mute control signal 440, the muter 506 may either pass or block the output audio 314, and may generate a conference bridge mute status signal 518 that indicates whether the muter 506 is passing or blocking the audio 314. The transmitter 524 may transmit the conference bridge mute status signal 518 over the channel 110.

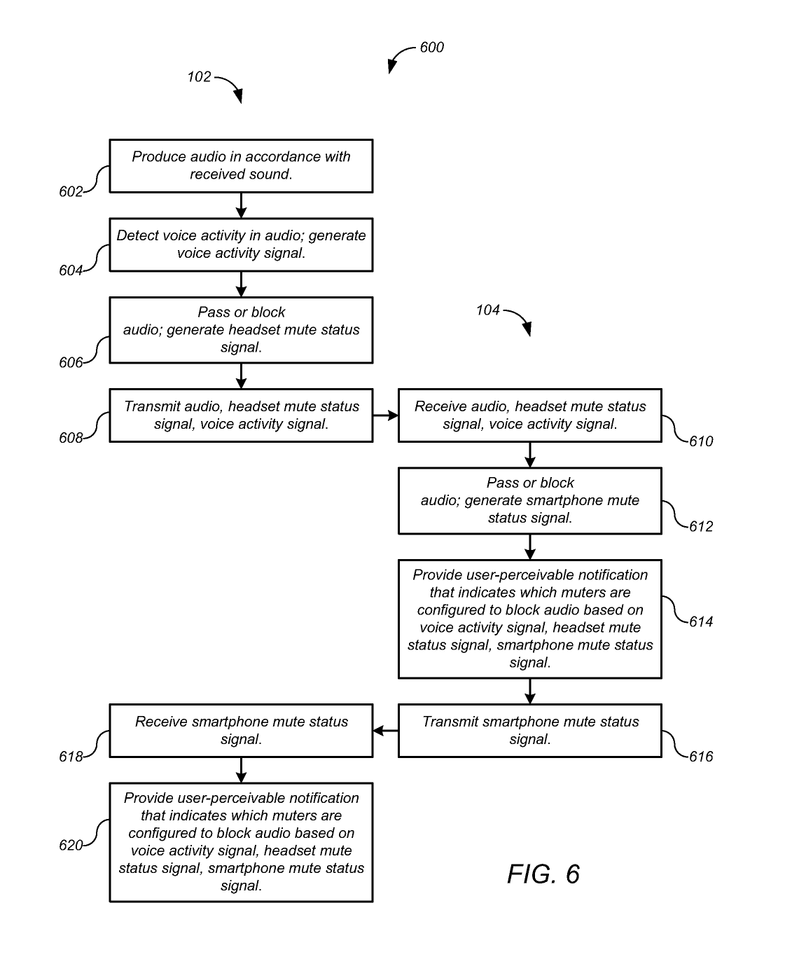

FIG. 6 shows a process 600 for the communication system 100 of FIG. 1 according to some embodiments of the present disclosure. Although in the described embodiments the elements of process 600 are presented in one arrangement, other embodiments may feature other arrangements. For example, in various embodiments, some or all of the elements of the process 600 may be executed in a different order, concurrently, and the like. Furthermore, some elements of the process 600 may not be performed, and may not be executed immediately after each other. In addition, some or all of the elements of the process 600 may be performed automatically, that is, without human intervention. For convenience, the elements of FIG. 6 are arranged in columns that are indicated with reference numerals 102 and 104 to indicate the functions of the headset 102 and the smartphone 104, respectively.

Referring now to FIG. 6, at 602, the microphone 302 of the headset 102 may produce audio 314 in accordance with sound received by the microphone 302. At 604, the voice activity detector 304 may detect the presence or absence of voice activity in the audio 314. The voice activity detector 304 may also generate a voice activity signal 316 that represents the detected presence or absence of voice activity. For example, the voice activity signal 316 may be a bi-level signal where one level indicates a presence of voice activity, and the other level indicates an absence of voice activity.

At 606, the muter 306 in the headset 102 may either pass or block the audio 314, for example in accordance with operation of a user-operable control. For example, the user may operate the mute button 312 on the headset 102. As another example, the user may operate a soft button on the smartphone 104. Responsive to such operations, the muter controller 310 may cause the muter 306 to pass or block the audio 314. The muter 306 may also generate a headset mute status signal 318 that indicates whether the muter 306 is passing or blocking the audio 314. For example, the headset mute status signal 318 may be a bi-level signal where one level indicates muting (that is, the muter 306 is blocking the audio 314), and the other level indicates no muting (that is, the muter 306 is passing the audio 314).

At 608, the transmitter 328 may transmit the audio 314 from the headset 102 over the channel 108. The transmitter 328 may transmit the headset mute status signal 318 over the channel 108. The transmitter 328 may transmit the voice activity signal 316 over the channel 108. At 610, the receiver 402 in the smartphone 104 may receive the audio 314 over the channel 110. The receiver 402 may receive the headset mute status signal 418 over the channel 108. The receiver 402 may receive the voice activity signal 416 over the channel 108.

At 612, the muter 406 in the smartphone 104 may either pass or block the audio 314, for example in accordance with operation of a user-operable control. For example, the user may operate the mute control 412 on the smartphone 104. Responsive to such an operation, the muter controller 410 may cause the muter 406 in the smartphone 104 to pass or block the audio 314. The muter 406 may also generate a smartphone mute status signal 418 that indicates whether the muter 406 is passing or blocking the audio 314. For example, the smartphone mute status signal 418 may be a bi-level signal where one level indicates muting (that is, the muter 406 is blocking the audio 314), and the other level indicates no muting (that is, the muter 406 is passing the audio 314).

At 614, the notifier 408 in the smartphone 104 may provide the user-perceivable notification 420 based on the voice activity signal 416 and one or both of the headset mute status signal 418 and the smartphone mute status signal 418. The notifier 408 may provide the user-perceivable notification 420 responsive to the contemporaneous occurrence of i) the voice activity signal 416 indicating the presence of voice activity, and ii) one or both of the muters 306, 406 being configured to block the audio 314. The user-perceivable notification 420 indicates which of the muters 306, 406 are configured to block the audio 314. For example, a display of the smartphone 104 may display messages, icons, or the like. For example, different LEDs or LED flashing patterns or vibration patterns may be used to indicate one or both of the muters 306, 406. For example, the audible message may indicate one or both of the muters 306, 406. At 616, the transmitter 424 may transmit the smartphone mute status signal 418 over the channel 108.

At 618, the receiver 330 in the headset 102 may receive the smartphone mute status signal 318. At 620, the notifier 308 in the headset 102 may provide the user-perceivable notification 320 based on the voice activity signal 316 and one or both of the headset mute status signal 318 and the smartphone mute status signal 418. The notifier 308 may provide the user-perceivable notification 320 responsive to the contemporaneous occurrence of i) the voice activity signal 316 indicating the presence of voice activity, and ii) one or both of the muters 306, 406 being configured to block the audio 314. The user-perceivable notification 320 may include vibration, light, sound, and the like. For example, the user-perceivable notification 320 may include illuminating a light source such as an LED, playing an audible message over the speaker 324, vibrating a vibrator, or the like. The user-perceivable notification 320 indicates which of the muters 306, 406 are configured to block the audio 314. For example, different LEDs or LED flashing patterns or vibration patterns may be used to indicate one or both of the muters 306, 406. For example, the audible message may indicate one or both of the muters 306, 406.

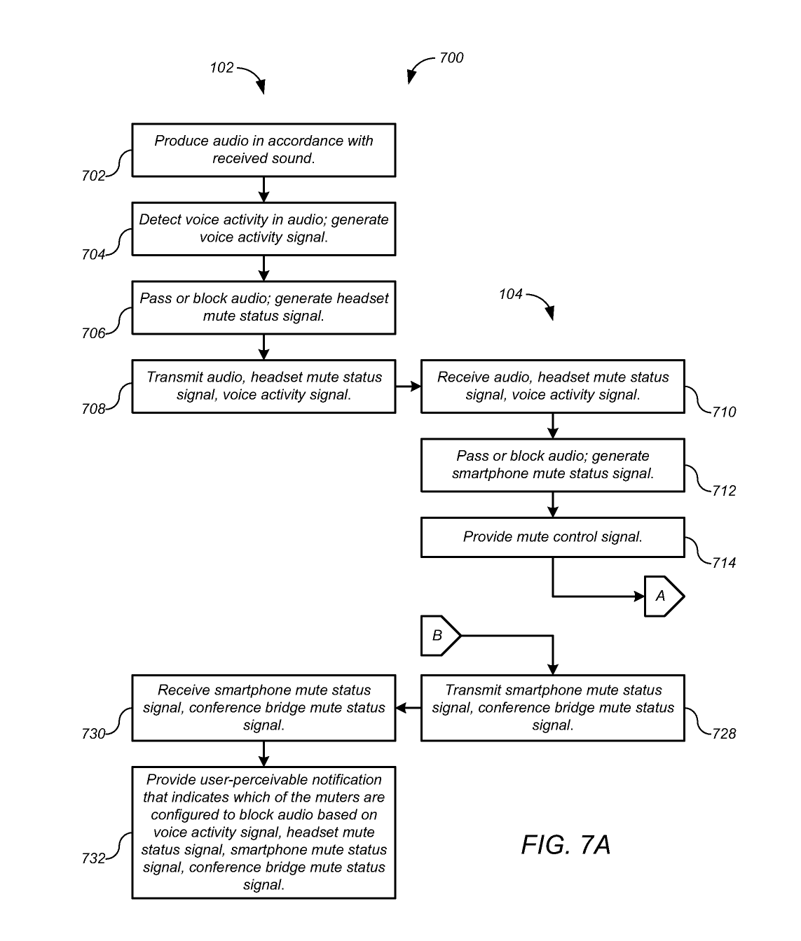

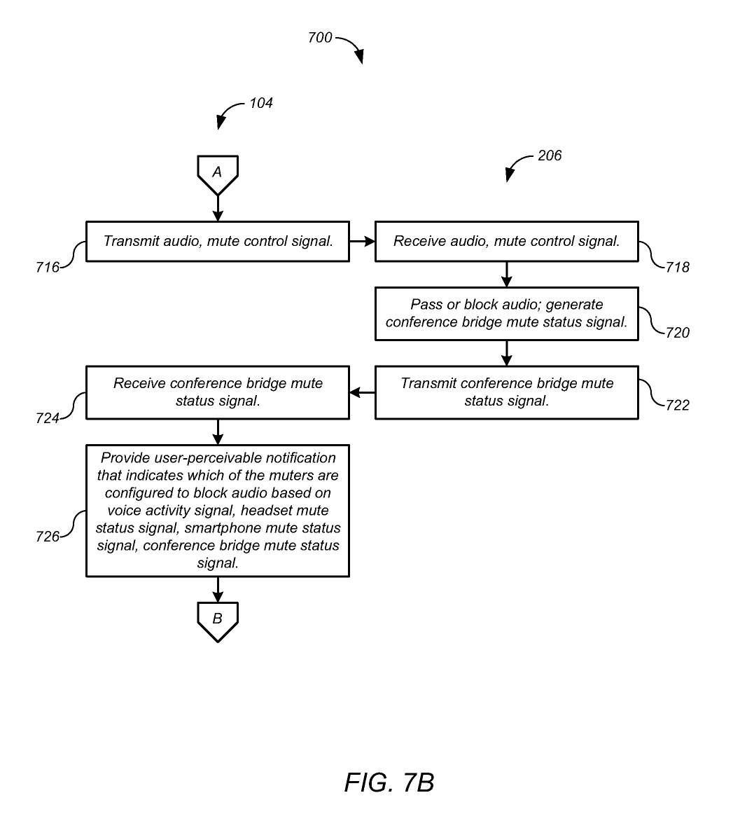

FIGS. 7A and 7B show a process 700 for the communication system 200 of FIG. 2 according to some embodiments of the present disclosure. Although in the described embodiments the elements of process 700 are presented in one arrangement, other embodiments may feature other arrangements. For example, in various embodiments, some or all of the elements of the process 700 may be executed in a different order, concurrently, and the like. Furthermore, some elements of the process 700 may not be performed, and may not be executed immediately after each other. In addition, some or all of the elements of the process 700 may be performed automatically, that is, without human intervention. For convenience, the elements of FIGS. 7A and 7B are arranged in columns that are indicated with reference numerals 102, 104, and 206 to indicate the functions of the headset 102, the smartphone 104, and the conference bridge 206, respectively. In addition, tabs marked A and B are used to show connections between the elements of FIGS. 7A and 7B.

Referring now to FIGS. 7A and 7B, at 702, the microphone 302 of the headset 102 may produce audio 314 in accordance with sound received by the microphone 302. At 704, the voice activity detector 304 may detect the presence or absence of voice activity in the audio 314. The voice activity detector 304 may also generate a voice activity signal 316 that represents the detected presence or absence of voice activity.

At 706, the muter 306 in the headset 102 may either pass or block the audio 314, for example in accordance with operation of a user-operable control. For example, the user may operate the mute button 312 on the headset 102. As another example, the user may operate a soft button on the smartphone 104. Responsive to such operations, the muter controller 310 may cause the muter 306 to pass or block the audio 314. The muter 306 may also generate a headset mute status signal 318 that indicates whether the muter 306 is passing or blocking the audio 314. For example, the headset mute status signal 318 may be a bi-level signal where one level indicates muting (that is, the muter 306 is blocking the audio 314), and the other level indicates no muting (that is, the muter 306 is passing the audio 314).

At 708, the transmitter 328 may transmit the audio 314 over the channel 108. The transmitter 328 may transmit the headset mute status signal 318 over the channel 108. The transmitter 328 may transmit the voice activity signal 316 over the channel 108. At 710, the receiver 402 in the smartphone 104 may receive the audio 314 over the channel 110. The receiver 402 may receive the headset mute status signal 318 over the channel 108. The receiver 402 may receive the voice activity signal 316 over the channel 108.

At 712, the muter 406 in the smartphone 104 may either pass or block the audio 314, for example in accordance with operation of a user-operable control. For example, the user may operate the mute control 412 on the smartphone 104. Responsive to such an operation, the muter controller 410 may cause the muter 406 in the smartphone 104 to pass or block the audio 314. The muter 406 may also generate a smartphone mute status signal 418 that indicates whether the muter 406 is passing or blocking the audio 314. For example, the smartphone mute status signal 418 may be a bi-level signal where one level indicates muting (that is, the muter 406 is blocking the audio 314), and the other level indicates no muting (that is, the muter 406 is passing the audio 314).

At 714, the mute control 412 may cause the muter controller 410 to provide the mute control signal 440. For example, a user may operate the mute control 412 to control the muter 506 in the conference bridge 206. At 716, the transmitter 428 may transmit the audio 314 over the channel 110. The transmitter 428 may transmit the mute control signal 440 over the channel 110. At 718, the receiver 502 in the conference bridge 206 may receive audio 314 over the channel 110. The receiver 502 may receive the mute control signal 440 over the channel 110. The mute control signal 440 may represent DTMF tones or the like. For example, the mute control signal 440 for a conference bridge may be the DTMF tones for the keys 5#. An app executing on the smartphone 104 may prompt the user for the correct tones on the first use, and remember those tones thereafter. The app may remember different tones for different conference bridges 206.

At 720, the muter 506 in the conference bridge 206 may either pass or block the audio 314. For example, responsive to the mute control signal 440, the muter controller 510 may cause the muter 506 in the conference bridge 206 to pass or block the audio 314. The muter 506 may also generate a conference bridge mute status signal 518 that indicates whether the muter 506 is passing or blocking the audio 314. For example, the conference bridge mute status signal 518 may be a bi-level signal where one level indicates muting (that is, the muter 506 is blocking the audio 314), and the other level indicates no muting (that is, the muter 506 is passing the audio 314). At 722, the transmitter 524 may transmit the conference bridge mute status signal 518 over the channel 110.

At 724, the receiver 430 in the smartphone 104 may receive a conference bridge mute status signal 418. At 726, the notifier 408 in the smartphone 104 may provide the user-perceivable notification 420 based on the voice activity signal 316 and one or more of the headset mute status signal 318, the smartphone mute status signal 418, and the conference bridge mute status signal 518. In some embodiments, rather than employ the conference bridge mute status signal 518, the notifier 408 simply keeps track of the state of the muter 506 in the conference bridge 206 based on the mute control signals 440 issued by the muter controller 410.

The notifier 408 may provide the user-perceivable notification 420 responsive to the contemporaneous occurrence of i) the voice activity signal 316 indicating the presence of voice activity, and ii) one or more of the muters 306, 406, 506 being configured to block the audio 314. The user-perceivable notification 420 indicates which of the muters 306, 406, 506 are configured to block the audio 314. For example, a display of the smartphone 104 may display messages, icons, or the like. For example, different LEDs or LED flashing patterns or vibration patterns may be used to indicate one or more of the muters 306, 406, 506. For example, the audible message may indicate one or more of the muters 306, 406, 506.

At 728, the transmitter 424 may transmit the smartphone mute status signal 418 over the channel 108. The transmitter 424 may transmit the conference bridge mute status signal 518 over the channel 108. At 730, the receiver 330 in the headset 102 may receive the smartphone mute status signal 418. The receiver 330 in the headset 102 may receive the conference bridge mute status signal 518.

At 732, the notifier 308 in the headset 102 may provide the user-perceivable notification 320 based on the voice activity signal 316 and one or more of the headset mute status signal 318, the smartphone mute status signal 418, and the conference bridge mute status signal 518. The notifier 308 may provide the user-perceivable notification 320 responsive to the contemporaneous occurrence of i) the voice activity signal 316 indicating the presence of voice activity, and ii) one or more of the muters 306, 406, 506 being configured to block the audio 314. The user-perceivable notification 320 may include vibration, light, sound, and the like. For example, the user-perceivable notification 320 may include illuminating a light source such as an LED, playing an audible message over the speaker 324, vibrating a vibrator, or the like. The user-perceivable notification 320 indicates which of the muters 306, 406, 506 are configured to block the audio 314. For example, different LEDs or LED flashing patterns or vibration patterns may be used to indicate one or more of the muters 306, 406, 506. For example, the audible message may indicate one or more of the muters 306, 406, 506.

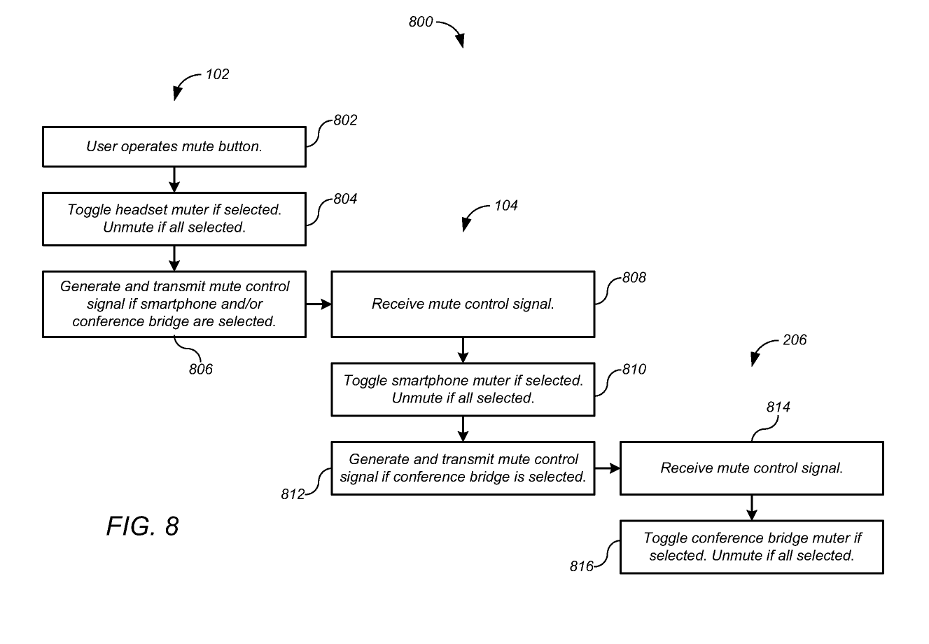

FIG. 8 shows a headset-controlled muting process 800 for the communication system 200 of FIG. 2 according to some embodiments of the present disclosure. Although in the described embodiments the elements of process 800 are presented in one arrangement, other embodiments may feature other arrangements. For example, in various embodiments, some or all of the elements of the process 800 may be executed in a different order, concurrently, and the like. Furthermore, some elements of the process 800 may not be performed, and may not be executed immediately after each other. In addition, some or all of the elements of the process 800 may be performed automatically, that is, without human intervention. For convenience, the elements of FIG. 8 are arranged in columns that are indicated with reference numerals 102, 104, and 206 to indicate the functions of the headset 102, the smartphone 104, and the conference bridge 206, respectively.

Referring now to FIG. 8, at 802, a user may operate the mute button 312 on the headset 102 to select one or more of the muters 306, 406, 506. For example, the user may use a single press to select the muter 306 in the headset 102, a double press to select the muter 406 in the smartphone 104, a triple press to select the muter 506 in the conference bridge 206, a long press to select all of the muters 306, 406, 506, and the like. Of course, other functions and controls may be used. At 804, if the muter 306 in the headset 102 is selected, the muter controller 310 may toggle the muter 306 between passing and blocking the audio 314. If all of the muters 306, 406, 506 are selected, the muter controller may unmute the headset muter 306.

At 806, if either or both of the muter 406 in the smartphone or the muter 506 in the conference bridge 206 is selected, then the muter controller 310 may provide an appropriate mute control signal 340. The transmitter 328 may transmit the mute control signal 340 over the channel 108.

At 808, the receiver 402 in the smartphone 104 may receive the mute control signal 440 over the channel 108. At 810, if the mute control signal 440 indicates that the muter 406 in the smartphone 104 is selected, the muter controller 410 may toggle the muter 406 between passing and blocking the audio 314. If all of the muters 306, 406, 506 are selected, the muter controller may unmute the smartphone muter 406.

At 812, if the muter 506 in the conference bridge 206 is selected, then the muter controller 410 may provide an appropriate mute control signal 440. The transmitter 428 may transmit the mute control signal 440 over the channel 110.

At 814, the receiver 502 in the conference bridge 206 may receive the mute control signal 440 over the channel 110. At 816, if the mute control signal 440 indicates that the muter 506 in the conference bridge 206 is selected, the muter controller 510 may toggle the muter 506 between passing and blocking the audio 314. If all of the muters 306, 406, 506 are selected, the muter controller may unmute the conference bridge muter 506.

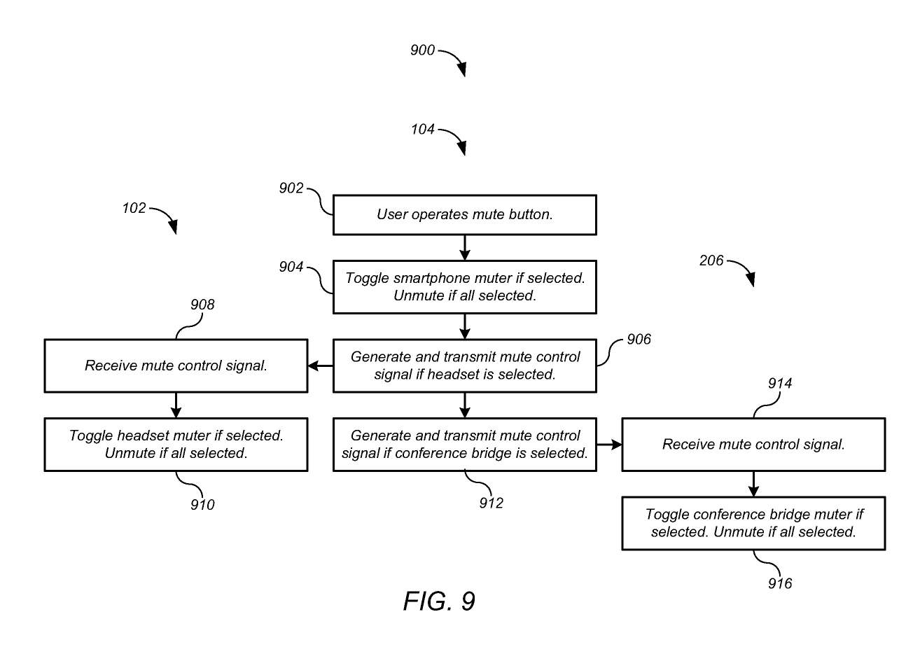

FIG. 9 shows a smartphone-controlled muting process 900 for the communication system 200 of FIG. 2 according to some embodiments of the present disclosure. Although in the described embodiments the elements of process 900 are presented in one arrangement, other embodiments may feature other arrangements. For example, in various embodiments, some or all of the elements of the process 900 may be executed in a different order, concurrently, and the like. Furthermore, some elements of the process 900 may not be performed, and may not be executed immediately after each other. In addition, some or all of the elements of the process 900 may be performed automatically, that is, without human intervention. For convenience, the elements of FIG. 9 are arranged in columns that are indicated with reference numerals 102, 104, and 206 to indicate the functions of the headset 102, the smartphone 104, and the conference bridge 206, respectively.

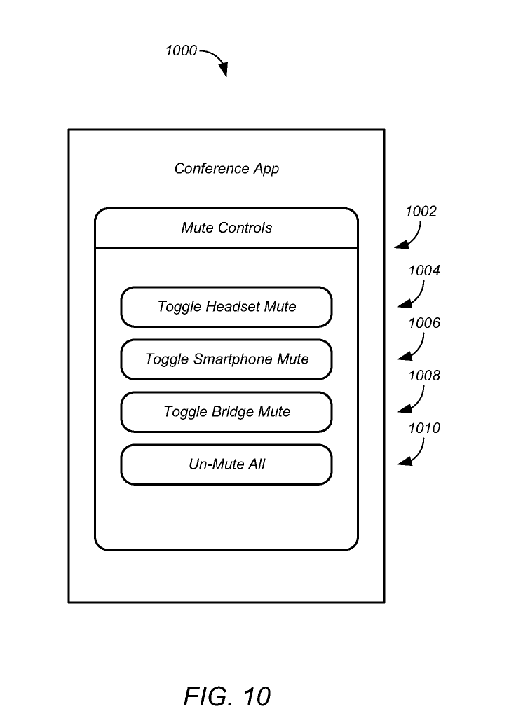

Referring now to FIG. 9, at 902, a user may operate the mute control 412 on the smartphone 104 to select one or more of the muters 306, 406, 506. For example, the user may operate soft buttons on a touchscreen display. FIG. 10 shows an example display 1000 for a conferencing app according to some embodiments of the present disclosure. The example display 1000 includes a panel 1002 of mute controls. The panel 1002 includes a soft button 1004 to toggle the muter 306 in the headset 102, a soft button 1006 to toggle the muter 406 in the smartphone 104, a soft button 1008 to toggle the muter 506 in the conference bridge 206, and a soft button 1010 to un-mute all of the muters 306, 406, 506. At 904, if the muter 406 in the smartphone 104 is selected, the muter controller 410 may toggle the muter 406 between passing and blocking the audio 314. If all of the muters 306, 406, 506 are selected, the muter controller may unmute the smartphone muter 506.

At 906, if the muter 306 in the headset 102 is selected, then the muter controller 410 may provide an appropriate mute control signal 440. The transmitter 424 may transmit the mute control signal 440 over the channel 108. At 908, the receiver 330 in the headset 102 may receive the mute control signal 340 over the channel 108. At 910, responsive to the mute control signal 340, the muter controller 310 may toggle the muter 306 between passing and blocking the audio 314. If all of the muters 306, 406, 506 are selected, the muter controller may unmute the headset muter 306.

At 912, if the muter 506 in the conference bridge 206 is selected, then the muter controller 410 may provide an appropriate mute control signal 440. The transmitter 424 may transmit the mute control signal 440 over the channel 108. At 914, the receiver 502 in the conference bridge 206 may receive the mute control signal 440 over the channel 110. At 916, responsive to the mute control signal 440, the muter controller 510 may toggle the muter 506 between passing and blocking the audio 314. If all of the muters 306, 406, 506 are selected, the muter controller may unmute the conference bridge muter 506.

Various embodiments of the present disclosure may be implemented in digital electronic circuitry, or in computer hardware, firmware, software, or in combinations thereof. Embodiments of the present disclosure may be implemented in a computer program product tangibly embodied in a computer-readable storage device for execution by a programmable processor. The described processes may be performed by a programmable processor executing a program of instructions to perform functions by operating on input data and generating output. Embodiments of the present disclosure may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, processors receive instructions and data from a read-only memory and/or a random access memory. Generally, a computer includes one or more mass storage devices for storing data files. Such devices include magnetic disks, such as internal hard disks and removable disks, magneto-optical disks; optical disks, and solid-state disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, ASICs (application-specific integrated circuits). As used herein, the term “module” may refer to any of the above implementations.

A number of implementations have been described. Nevertheless, various modifications may be made without departing from the scope of the disclosure. Accordingly, other implementations are within the scope of the following claims.

What is claimed is:

1. A communication device comprising:
a receiver configured to receive, into the communication device,
i) audio transmitted by a headset,
ii) a voice activity notification, wherein the voice activity notification indicates the headset is detecting voice activity in the audio,
iii) a mute status notification, wherein the mute status notification indicates whether a first muter in the headset is configured to block or pass the audio;
a second muter configured to pass or block the audio; and
a notifier configured to provide a user-perceivable notification responsive to contemporaneous occurrence of
i) the headset detecting the voice activity, and
ii) one or both of the first and second muters being configured to block the audio;
wherein the user-perceivable notification indicates which of the first and second muters are configured to block the audio.

2. The communication device of claim 1, further comprising:
a user-operable control; and
a muter controller configured to configure the first and second muters to both pass or both block the audio responsive to operation of the user-operable control.

3. The communication device of claim 1, further comprising:
a user-operable control configured to select one of the first and second muters; and
a muter controller configured to configure the one of the first and second muters to pass or block the audio responsive to operation of the user-operable control.

4. The communication device of claim 1, further comprising:
a transmitter configured to transmit a message from the communication device, wherein the message indicates which of the first and second muters are configured to block the audio.

5. The communication device of claim 1, wherein the receiver is a first receiver, wherein the mute status notification is a first mute status notification, and wherein the communication device further comprises:
a transmitter configured to transmit the audio; and
a second receiver configured to receive a second mute status notification from a conference bridge receiving the audio, wherein the second mute status notification indicates whether a third muter in the conference bridge is configured to block the audio;
wherein the notifier is further configured to provide the user-perceivable notification responsive to contemporaneous occurrence of
i) the headset detecting the voice activity, and
ii) one or more of the first, second and third muters being configured to block the audio;
wherein the user-perceivable notification indicates which of the first, second and third muters are configured to block the audio.

6. The communication device of claim 5, wherein:
the transmitter is further configured to transmit a message from the communication device, wherein the message indicates which of the first, second and third muters are configured to block the audio.

7. The communication device of claim 5, further comprising:
a user-operable control; and
a muter controller configured to configure the first, second and third muters to all pass or all block the audio responsive to operation of the user-operable control.

8. A headset comprising:
a microphone;
a transmitter configured to transmit, from the headset, audio produced by the microphone;
a voice activity detector configured to detect voice activity in the audio;
a first muter configured to i) pass the audio to the transmitter, or ii) block the audio from reaching the transmitter;
a receiver configured to receive a mute status notification into the headset, wherein the mute status notification indicates whether a second muter, disposed in a communication device receiving the audio from the headset, is configured to block the audio; and
a notifier configured to provide a user-perceivable notification responsive to contemporaneous occurrence of
i) the voice activity detector detecting the voice activity in the audio, and
ii) one or both of the first and second muters being configured to block the audio;
wherein the user-perceivable notification identifies which of the first and second muters is configured to block the audio.

9. The headset of claim 8, further comprising:
a user-operable control; and
a muter controller configured to configure the first and second muters to both pass or both block the audio responsive to operation of the user-operable control.

10. The headset of claim 8, further comprising:
a user-operable control configured to select one of the first and second muters; and
a muter controller configured to configure the one of the first and second muters to pass or block the audio responsive to operation of the respective user-operable control.

11. The headset of claim 8, wherein:
the transmitter is further configured to transmit a message from the headset, wherein the message indicates which of the first and second muters are configured to block the audio.

12. The headset of claim 8, wherein:
the mute status notification is a first mute status notification;
the receiver is further configured to receive a second mute status notification, wherein the second mute status notification indicates whether a third muter, disposed in a conference bridge receiving the audio, is configured to block the audio;
the notifier is further configured to provide the user-perceivable notification responsive to contemporaneous occurrence of
i) the voice activity detector detecting the voice activity in the audio, and
ii) one or more of the first, second and third muters being configured to block the audio; and
the user-perceivable notification indicates which of the first, second and third muters are configured to block the audio.

13. The headset of claim 12, wherein:
the transmitter is further configured to transmit a message from the headset, wherein the message indicates which of the first, second and third muters are configured to block the audio.

14. The headset of claim 12, further comprising:
a user-operable control; and
a muter controller configured to configure the first, second and third muters to all pass or all block the audio responsive to operation of the user-operable control.

15. Computer-readable non-transitory media embodying instructions executable by a computer disposed in a communication device to perform functions comprising:
receiving audio from a headset;
receiving a voice activity notification, wherein the voice activity notification indicates voice activity being detected in the audio;
receiving a mute status notification, wherein the mute status notification indicates whether a first muter in the headset is configured to block or pass the audio;
determining whether a second muter disposed in the communication device is configured to pass or block the audio; and
causing a notifier to provide a user-perceivable notification responsive to contemporaneous occurrence of
i) the voice activity being detected in the audio, and
ii) one or both of the first and second muters being configured to block the audio;
wherein the user-perceivable notification indicates which of the first and second muters are configured to block the audio.

16. The computer-readable non-transitory media of claim 15, wherein the functions further comprise:
causing a muter controller disposed in the communication device to configure the first and second muters to both pass or both block the audio responsive to operation of a user-operable control disposed in the communication device.

17. The computer-readable non-transitory media of claim 15, wherein the functions further comprise:
causing a muter controller disposed in the communication device to configure one of the first and second muters to pass or block the audio responsive to operation of a user-operable control disposed in the communication device.

18. The computer-readable non-transitory media of claim 15, wherein the functions further comprise:
causing a transmitter disposed in the communication device to transmit a message from the communication device, wherein the message indicates which of the first and second muters are configured to block the audio.

19. The computer-readable non-transitory media of claim 15, wherein the receiver is a first receiver, wherein the mute status notification is a first mute status notification, and wherein the functions further comprise:
causing a transmitter disposed in the communication device to transmit the audio;
receiving a second mute status notification from a conference bridge receiving the audio, wherein the second mute status notification indicates whether a third muter in the conference bridge is configured to block the audio; and
causing the notifier to provide the user-perceivable notification responsive to contemporaneous occurrence of
i) the voice activity being detected in the audio, and
ii) one or more of the first, second and third muters being configured to block the audio;
wherein the user-perceivable notification indicates which of the first, second and third muters are configured to block the audio.

20. The computer-readable non-transitory media of claim 19, wherein the functions further comprise:
causing a muter controller disposed in the communication device to configure the first, second and third muters to all pass or all block the audio responsive to operation of a user-operable control disposed in the communication device.
